(19) United States
(12) Patent Application Publication
(10) Pub. No.: US 2005/0188762 A1
(43) Pub. Date: Sep. 1, 2005

(54) Volumetric fluid meter

(76) Inventors: Frederic Droin, Liergnes (FR); Laurent Demia, Momtluel (FR)

Correspondence Address: SOFER & HAROUN, L.L.P., Suite 910, 317 Madison Avenue, New York, NY, 10017, US

(21) Appl. No.: 10/616,238

(22) Filed: Jul. 8, 2003

(30) Foreign Application Priority Data
Jul. 9, 2002 (FR) 02 09000

(51) Int. Cl. G01F 3/08

(52) U.S. Cl. 73/253

(57) ABSTRACT

The invention relates to the technical field of oscillating piston volumetric fluid meters. The meter comprises a cylindrical measuring chamber including a lateral wall (2), a bottom (1) and a lid (3), a lower cylinder (4) and an upper cylinder (5) having the same diameter, which is less than the diameter of said chamber, an inlet orifice and an outlet orifice (8) for respectively admitting fluid to and evacuating fluid from said chamber, a cylindrical piston (11) disposed eccentrically and guided kinematically in said chamber and effecting an oscillatory movement in said chamber (30) as a result of the displacement of a volume of fluid, and a fixed partition (9) between said inlet orifice and said outlet orifice (8), lying radially between said lateral wall (2) and said lower and upper cylinders (4, 5), and lying axially between said bottom (1) and said lid (3), said lateral wall (2) including a vertical cavity (16) in the vicinity of said fixed partition (9). Said cavity (16) is separate from said inlet and outlet orifices and passes through said lateral wall (2) at least partly within the height of said wall.

The invention relates to a volumetric fluid meter adapted to measure the flowrate of a fluid flowing in a pipe.

The invention relates more particularly to the technical field of oscillating piston volumetric fluid meters, the technology of which is well known to the person skilled in the art.

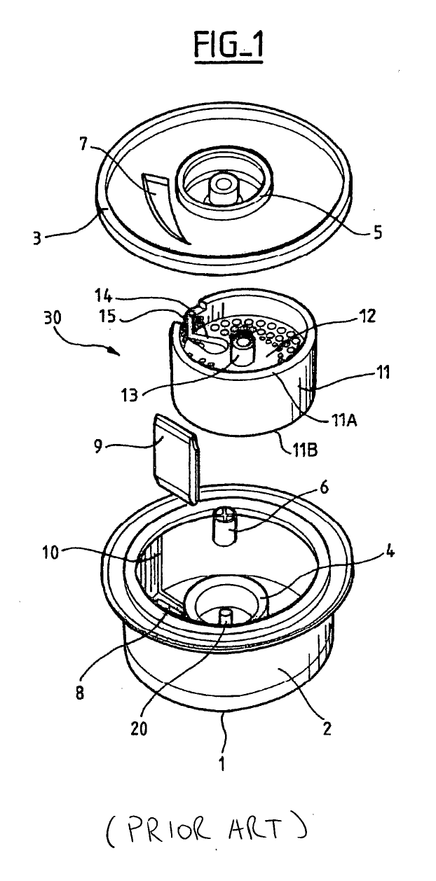

As shown in the FIG. 1 exploded perspective view, a prior art meter of the above kind includes a measuring box.

In this type of meter, the measuring box is the key component on which the accuracy of the flowrate measurement depends. The measuring box is a cylindrical chamber 30 which has a bottom 1, a lateral wall 2, and a lid 3. The bottom 1 and the lid 3 respectively comprise a lower cylinder 4 and an upper cylinder 5, of the same diameter, which is less than that of the chamber. The two cylinders 4, 5 are centered on the axis of the chamber. The lower cylinder has at its center a metal rod 28 over which is nested a roller 6. The bottom and the lid have an inlet aperture 7 and an output aperture 8 for entry of fluid into the chamber and evacuation of fluid from the chamber, respectively. The chamber 30 also includes a fixed rectangular partition 9 between the inlet orifice 7 and the output orifice 8. The partition extends radially between the lateral wall 2 and the lower and upper cylinders 4, 5 and axially between the bottom 1 and the lid 3. The bottom, the lateral wall, the lid and the lower and upper cylinders incorporate a groove 10 in which the partition is engaged. A cylindrical piston 11 whose diameter is less than that of the chamber but greater than the diameters of the lower and upper cylinders is positioned eccentrically within the chamber. The piston 11 has at mid-height a plane wall 12 perforated with holes and supporting at its center two nipples 13, one directed toward the bottom and the other toward the lid. The wall further includes a pear-shaped opening 14 oriented radially and positioned eccentrically. The pear-shaped opening opens onto a slot running the full height of the piston.

The meter incorporating the above kind of measuring box operates in accordance with the principle of admitting into the chamber 30 via the inlet orifice 7 a given volume of fluid which, by communicating its energy to the piston, causes the latter to move in rotation, and evacuating the given volume of fluid via the outlet orifice 8. Accordingly, each revolution of the piston 11 corresponds to the passage of a given volume of fluid. The general movement of the piston is an oscillatory movement with the axis of the piston describing a circle around the axis of the chamber 30 and the slot 15 in the piston sliding along the partition 9. The piston is guided kinematically in the chamber 30 by virtue of the engagement of the partition 9 in the vertical slot 15 and in the pear-shaped opening 14 and the engagement of the nipple 13 between the roller 6 and the lower cylinder 4. Although it is positioned between the lower cylinder 4 and the upper cylinder 5, the plane wall of the piston remains free to move in a plane.

The invention therefore relates to an oscillating piston volumetric fluid meter comprising a cylindrical chamber including a lateral wall, a bottom and a lid, and a cylindrical piston disposed eccentrically and guided kinematically in the chamber, the piston effecting an oscillatory movement in the chamber caused by the displacement of a volume of fluid and having faces sliding on fixed parts of the chamber.

A particular problem associated with this type of meter is its poor behavior when metering water transporting solid particles such as grains of sand. This is because the clearances between the various components of the chamber are such that a mere grain of sand can completely block movement of the piston or at least cause a significant reduction in metrological performance over time. The effect of these solid particles is particularly harmful at the corners of the fixed partition between the inlet orifice and the outlet orifice. At present this weakness excludes this metering technology from many markets in geographical areas in which the water is “charged”. Likewise, the water may contain solid particles when working on a network in connection with commissioning or maintenance operations.

Document WO93/22631 describes a solution to the problem, and to this end describes a volumetric meter comprising a groove on a wall of a measuring chamber in the vicinity of a fixed partition between an inlet orifice and an outlet orifice, the groove enabling evacuation of solid particles in the fluid via an enlargement of the surface of the outlet orifice to which the groove leads. This groove prevents accumulation of particles between the outside diameter of the piston and the inside diameter of the measuring chamber.

However, using it gives rise to certain problems in that the rate of evacuation of the solid particles is not always sufficient in the case of heavily “charged” water. Because the particles must be evacuated via this small section groove, the flowrate is sometimes insufficient, which can lead to recirculation of particles or immobilization of particles in the groove.

The present invention aims to provide an oscillating piston volumetric fluid meter offering an improved particle evacuation flowrate.

To this end the present invention proposes an oscillating piston volumetric fluid meter comprising a cylindrical measuring chamber including:
a lateral wall,
a bottom and a lid,
a lower cylinder and an upper cylinder having the same diameter, which is less than the diameter of said chamber,
an inlet orifice and an outlet orifice for respectively admitting fluid to and evacuating fluid from said chamber,
a cylindrical piston disposed eccentrically and guided kinematically in said chamber and effecting an oscillatory movement in said chamber as a result of the displacement of a volume of fluid, and
a fixed partition between said inlet orifice and said outlet orifice, lying radially between said lateral wall and said lower and upper cylinders, and lying axially between said bottom and said lid,
said lateral wall including a vertical cavity in the vicinity of said fixed partition,
which meter is characterized in that said cavity is separate from said inlet and outlet orifices and passes through said lateral wall at least partly within the height of said wall.

Thanks to the invention, particles are evacuated over at least a portion of the height of the chamber, thereby leading to a flowrate that is improved compared to evacuation via only a small section enlargement of the surface of the orifice. This cavity evacuates more effectively particles situated between the outside diameter of the piston and the inside diameter of the measuring chamber.

In a first embodiment, the cavity is on the same side of said fixed partition as the outlet orifice.

In a second embodiment, the cavity is on the same side of said fixed partition as the inlet orifice.

The cavity is advantageously a vertical slot parallel to a vertical edge of said fixed partition.

Said slot is advantageously tangential to said fixed partition.

Said slot advantageously has a width less than or equal to 3 mm.

In a third embodiment, said lateral wall includes two cavities each on either side of said fixed partition.

In a particularly advantageous embodiment, the volumetric meter includes a vertical groove extending at least partly along said lower and upper cylinders, in communication with one of said inlet and outlet orifices, and in the vicinity of said fixed partition.

Thus the meter avoids immobilization of solid particles between the interior diameter of the piston and the exterior diameter of the lower and upper cylinders of the chamber. It also enables evacuation of particles via one of the orifices.

Said vertical groove is advantageously tangential to said fixed partition.

Said vertical groove advantageously has a width less than or equal to 2 mm.

Other features and advantages of the present invention will become apparent in the course of the following description of one embodiment of the invention, which is given by way of illustrative and nonlimiting example.

In the drawings:

FIG. 1 is an exploded perspective view of a prior art oscillating piston volumetric meter,

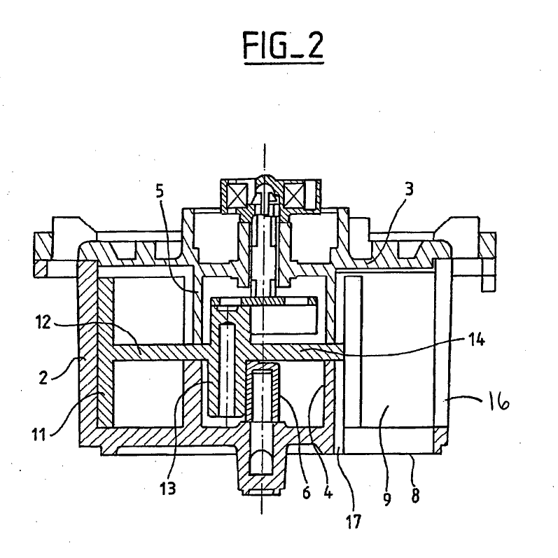

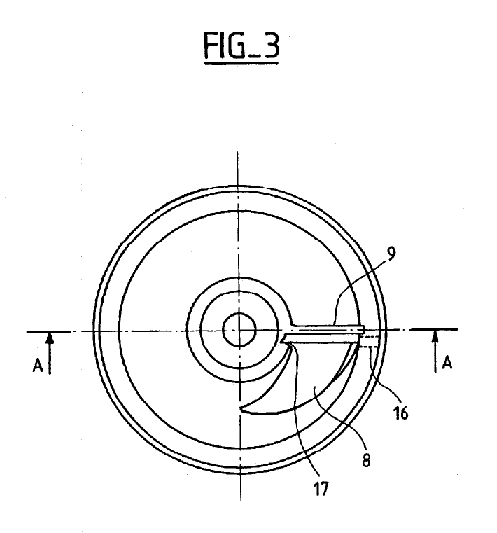

FIG. 2 is a view in vertical section taken along the line AA in FIG. 3 of a volumetric meter according to the invention,

FIG. 3 is a plan view of a volumetric meter according to the invention without the piston and the lid,

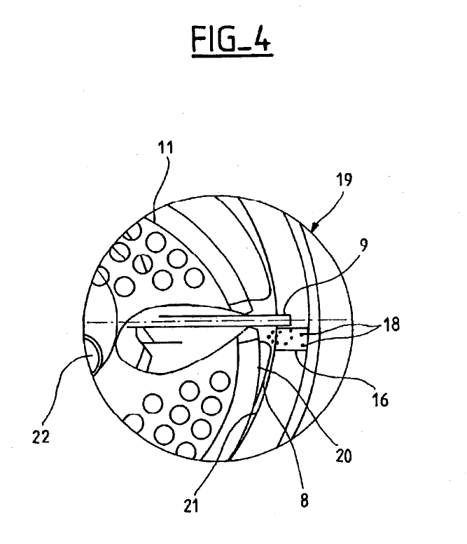

FIG. 4 is a plan view to a larger scale of a first portion surrounding the fixed wall of a volumetric meter according to the invention, and

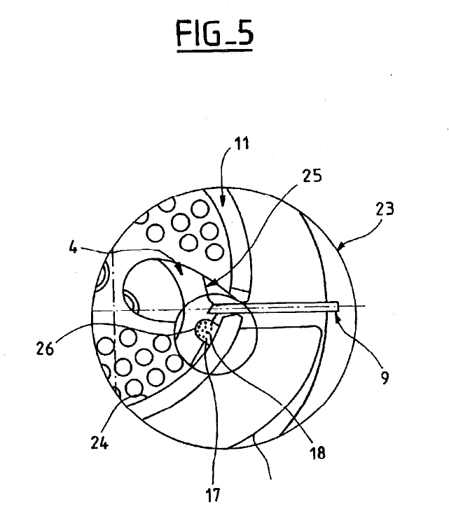

FIG. 5 is a plan view to a larger scale of a second portion surrounding the fixed wall of a volumetric meter according to the invention.

Items common to more than one figure are identified by the same reference number in all the figures in which they appear.

FIG. 1 has already been described in connection with the prior art.

FIG. 3 is a plan view of a volumetric meter according to the invention. FIG. 2 is a view of the same volumetric meter according to the invention in vertical section taken along the line AA in FIG. 3.

For reasons of clarity, the piston 11 and the lid 3 shown in FIG. 2 are intentionally omitted from FIG. 3.

The lateral wall 2 of the measuring chamber includes a vertical slot 16 through the lateral wall 2. The vertical slot 16 is tangential to the fixed partition 9 between the inlet orifice (not shown) and the outlet orifice 8, and is on the same side of the fixed partition as the outlet orifice 8, as shown in FIG. 3. The width of the slot 16 is less than or equal to 3 mm and its height is approximately equal to the height of the fixed partition 9.

The upper cylinder 5 incorporates a vertical groove 17 tangential to the fixed partition 9 and extended on the lower cylinder 4. The section of the outlet orifice 8 is enlarged so that the vertical groove 17 opens into the enlargement. The vertical groove 17 therefore extends the entire length of the measuring chamber.

FIG. 4 is a plan view to a larger scale of a part 19 surrounding the fixed wall 9 and shows how the vertical slot 16 of a meter according to the invention works.

During each admission of a given volume of fluid through the inlet orifice, not shown, the axis 22 of the piston 11 describes a complete circular movement, leading to an oscillatory movement of the piston 11 and evacuation of the given volume of fluid via the outlet orifice 8. A “charged” fluid contains solid particles 18 that take up a position between the exterior diameter 20 of the piston 11 and the interior diameter 21 of the measuring chamber. These particles are evacuated via the slot 16, and thus over a height approximately equal to the height of the fixed partition 9. Moreover, the narrowness of the slot 16 in conjunction with its proximity to the fixed partition 9 leads to the fluid escaping via the slot 16 without impacting on the metrology of the meter. This is because the small width induces a low loss and its proximity to the fixed partition 9 means that the particles 18 are evacuated at a time when the greater portion of the given volume of fluid has already been metered, in other words just before the end of a complete rotation of the axis 22 of the piston 11.

FIG. 5 is a plan view to a larger scale of a second portion 23 surrounding the fixed partition 9, showing how the vertical groove 17 of the meter according to the invention works.

A “charged” fluid contains solid particles 18 that take up a position between the interior diameter 24 of the piston and the exterior diameter 25 of the lower cylinder 4 and the upper cylinder (not shown) of the measuring chamber. The groove 17 is on both the lower cylinder 4 and the upper cylinder, and enables the particles 18 to flow.

The groove 17 opens onto an enlargement 26 of the outlet orifice 8 which evacuates particles 18 flowing along the groove 17. The section of the enlargement 26 is substantially identical to the section of the groove 17, and thus small compared to the section of the output orifice 8, in order not to interfere with metrology.

Of course, the invention is not limited to the embodiment just described.

Accordingly, although the slot 16 and the groove 17 are used with the common aim of evacuating particles, the vertical slot can be used alone and effectively evacuate solid particles.

Moreover, in the embodiment described the slot and the groove are on the same side as the outlet orifice, but they could equally well be on the same side as the inlet orifice.

Furthermore, a slot and a groove could equally well be provided on each side of the fixed partition.

1. An oscillating piston volumetric fluid meter having a cylindrical measuring chamber comprising:
a lateral wall,
a bottom and a lid,
a lower cylinder and an upper cylinder having the same diameter, which is less than the diameter of said chamber,
an inlet orifice and an outlet orifice for respectively admitting fluid to and evacuating fluid from said chamber,
a cylindrical piston disposed eccentrically and guided kinematically in said chamber and effecting an oscillatory movement in said chamber as a result of the displacement of a volume of fluid, and
a fixed partition between said inlet orifice and said outlet orifice lying radially between said lateral wall and said lower and upper cylinders and lying axially between said bottom and said lid said lateral wall including a vertical cavity in the vicinity of said fixed partition, is configured such that said cavity is separate from said inlet and outlet orifices and passes through said lateral wall at least partly along the height of said wall.

2. A volumetric meter according to claim 1 characterized in that said cavity is on the same side of said fixed partition as said outlet orifice.

3. A volumetric meter according to claim 1 characterized in that said cavity is on the same side of said fixed partition as said inlet orifice.

4. A volumetric meter according to the preceding claim characterized in that said cavity is a vertical slot parallel to a vertical edge of said fixed partition.

5. A volumetric meter according to the preceding claim characterized in that said slot is tangential to said fixed partition.

6. A volumetric meter according to the preceding claim characterized in that said slot has a width less than or equal to 3 mm.

7. A volumetric meter according to the preceding claim characterized in that said lateral wall includes two cavities each on either side of said fixed partition.

8. A volumetric meter according to the preceding claim characterized in that it includes a vertical groove extending along said lower and upper cylinders, in communication with one of said inlet and outlet orifices, and in the vicinity of said fixed partition.

9. A volumetric meter according to claim 8 characterized in that said vertical groove is tangential to said fixed partition.

10. A volumetric meter according to claim 8 characterized in that said vertical groove has a width less than or equal to 2 mm.
